(19) United States
(12) Patent Application Publication
(10) Pub. No.: US 2006/0255592 A1
(43) Pub. Date: Nov. 16, 2006

(54) Splicing Device and Method for Sealing Conduit Spaces

(76) Inventors: John T. Minemyer, Colorado Springs, CO (US); Herbert V. Smith, Littleton, CO (US); Gregory T. Payne, Littleton, CO (US); Victoria DiMambro, Reno, NV (US)

Correspondence Address: BAKER BOTTS L.L.P., 2001 ROSS AVENUE, SUITE 600, DALLAS, TX, 75201-2980, US

(21) Appl. No.: 11/458,587

(22) Filed: Jul. 19, 2006

Related U.S. Application Data
(63) Continuation of application No. 10/416,317, filed on Jul. 16, 2004, now abandoned.

(51) Int. Cl. F16L 17/00; F16L 19/00; F16L 21/02

(52) U.S. Cl. 285/373

(57) ABSTRACT

A splicing device (10) is provided for sealing a conduit space (14) between two pipe sections (16,18). The splicing device includes a first body (20) and a second body (60) that are formed as an integral one-piece. A pair of clasp members (101) are mounted on the first and second body sections to secure them in an assembled state. To allow for mechanical advantage in closing the clasp members, each member is provided with an outwardly oriented ear (111) that can be engaged to a tool to force the members towards one another.

### FIELD OF THE INVENTION

The present invention broadly concerns sealing spaces in conduit. The invention more specifically concerns sealing the abutting ends of two sections of conduit in an airtight manner. This invention particularly is directed to a device which mounts on the external surface of innerduct in order to connect two sections of innerduct together in an air tight manner.

### BACKGROUND OF THE INVENTION

The use of conduits and ducts has been wide-spread for a substantial period of history. The use of networks of piping dates back at least to Roman Empire times wherein lead pipes were used to convey water for domestic use. Conduits, ducts and the like have been used to carry a variety of fluids, both liquid and gaseous in industry environments. Indeed, conduits are sometimes used to convey particulate matter from one location to another.

In addition to their ability to convey materials, conduits have been used to provide a protected environment in other mechanical and electrical applications. For example, metal conduit is often employed to enclose power wires and cables in order to prevent damage to those wires especially in situations where the wire might otherwise be subjected to damage. Here, the conduit acts as a protective housing with a passageway through which wiring may be extended. The metal sleeve prevents exposure of the wiring to the external environment that may otherwise not only subject the wiring to damage from the environment but also which serves to protect people and animals from exposure to the electrical current carried by the wires.

In recent years, there has been impetus to place power cables, telecommunication cables and the like underground. On one hand, placing the cables underground eliminates telephone poles or electrical poles that are expensive to erect and maintain. The elimination of such poles provide a more aesthetically pleasing environment since the distraction of the poles and wiring extending therebetween can create an unsightly appearance in a neighborhood. Moreover, the placing of electrical and telecommunication cables underground reduces the likelihood of damage to these important utilities. Where telephone or electric poles are used, strong winds can break the poles which in turn can break the wiring. This not only interrupts the utility service but also poses a threat where electrical power lines become severed. Accordingly, placing the power lines and telecommunications underground both protects the cables from damage and also protects the environment and individuals in the environment from damage from those cables. Placing electrical and telecommunications underground, however, is not without its difficulties. Placing these cables underground exposes them to a greater threat of mold, mildew and water damage. In addition, such cables become more readily acceptable to insects and vermin.

Recent times have seen a greater demand for telecommunication cables as the need for data transport at greater volumes and speeds has increased. The need to transport audio information, video information and data rapidly in high volumes has stimulated the use of fiber optic cable as a medium for transportation. Fiber optic cable normally employs long strands of light transmissive fibers which are constructed so that light introduced at one end will be substantially internally reflected throughout the length of the fiber so as to exit at an opposite end with relatively low loss. Laser light is then transmitted through such fiber optic cables with the light being encoded with the data (usually digital) to be transmitted.

In fiber optic applications, bundles of fiber optic strands are typically employed for a fiber optic cable. Due to the fragile nature of the fiber optic material, the fiber optic cables are usually protected by means of a conduit housing or innerduct. Innerduct is a type of conduit or tubing produced of a suitable polymer material that is extruded in a hose-like manner. Sections of this conduit are typically buried, and the fiber optic cable is introduced through the conduit by means of air pressure acting on a chute apparatus that drags the cable through the conduit under the influence of pressurized air. Where two ends of conduit section come together or abut one another, it is therefore necessary to seal such junction as substantially as possible. If no seal is achieved, it becomes difficult to introduce the fiber optic cable through the conduit since a leak will cause a pressure drop in the force provided to drag the cable through the conduit. Moreover, a space between adjoining pieces of conduit or a rupture of the conduit sidewall will expose the fiber optic cable to the potential damages from water seepage, insects and the like.

It has therefore been desirable to connect sections of conduit together in a manner that is as sealed as possible recognizing that no seal is necessarily perfect. In order to accomplish these seals, several different techniques have been employed in the past. One such method employs a compression fitting that is pushed onto each end of the innerduct under a compression load. Such press-on couplings are provided with circumferential barbs that bite into the duct and thereby provide both strength against pull-out separation and a seal around the exterior surface of the coupling. Such press-on couplings, however, require the use of a hydraulic or mechanical coupling press to mount onto the ends of the conduit. As an alternative to the press-on couplings, external thread-on couplings have been used. Typically, these thread-on couplings are made of a metal, such as aluminum. Opposite ends of the coupling are respectively threaded with right-hand threads and left-hand threads so that rotation of the coupling draws the ends of the conduit together and seals the junction. Internal couplings have also been used which fit into the inside of the conduit. Here, the couplings can either be circumferential barbs or threads that engage the interior surface of the conduit. Both threaded and press-on internal couplings are known.

As an alternative to smooth walled conduit, it is known to provide corrugated innerduct. Corrugated innerduct has an external surface formed with circumferential grooves and circumferential ribs. For such corrugated conduit, it is known to provide a two-piece external coupling. Here, an inner component is formed as a “clam-shell” and provides a sleeve that mounts over the conduit. This component has radially inwardly projecting ribs that engage the grooves on the corrugated conduit so as to prevent axial movement. Once the internal component has been placed in position, an outer sleeve is slid over the inner component to prevent release of its clam shell grip. In such applications, it is known also to use an adhesive compound to help obtain an air tight seal.

While the above-described structures adequately address some of the needs for joining sections of conduit together, they are not without their disadvantages. Metal couplings tend to be expensive to manufacture and do not always provide the desired seal. Moreover, these devices are relatively expensive to produce so that costs incurred in using such couplings can be substantial. The use of the standard two-piece coupling, described above, requires specialized conduit in order to function so that these couplings are not typically employed with the easily manufactured and inexpensive smooth surface extrusion conduit that is prevalent in the industry. Accordingly, there is a need for better couplings to interconnect sections of conduit or otherwise seal spaces that occur in a conduit or innerduct system. The present invention is directed to such need.

### SUMMARY OF THE INVENTION

It is an object of the present invention to provide a new and useful splicing device that can be employed to seal a space in a conduit.

A further object of the present invention is to provide a new and useful splicing device especially adapted to connect to and join, in a sealed manner, the abutting ends of two conduit sections.

Another object of the present invention is to provide a clamp-on splicing device that can be mounted to the exterior of a conduit so as to provide a seal therearound.

It is a further object of the present invention to provide an inexpensive splicing device or coupling which can be conveniently injection molded at a relatively low cost.

Yet another object of the present invention is to provide a splicing device that is easy to use, that reduces installation costs and that requires no specialized tools or equipment.

It is a further object of the present invention to provide a splicing device that effectively seals a space in a conduit by simple mechanical compression yet that can also receive flowable adhesives for enhancing its seal.

Still a further object of the present invention is to provide a method of joining two pieces of conduit together to seal a space therebetween.

In order to accomplish these objects, then, the present invention is directed to a splicing device adapted to mount around a portion of conduit of pre-determined size and cross-sectional geometry to seal a space therein. Broadly, the splicing device of the present invention includes first and second body sections that are securable together in an assembled state thereby to form a sleeve having a selected cross-sectional geometry similar to the conduit and sized to surround the portion of the conduit containing the space. At least one clasp member is provided to secure the first and second sections together and to retain them in the assembled state. Each of the first and second body sections includes a sidewall forming a longitudinal channel with the sidewall having a pair of lateral side edges and opposite end edges. The lateral side edges of the first and second body sections are oriented to confront one another as confronting edge pairs when in the assembled state such that the channels in the first and second body sections form an axially extending chamber having a central longitudinal axis. The sleeve formed by the assembly of the first and second body sections is adapted for close-fitted engagement with the exterior surface of the conduit. Each of the first and second body sections, then, includes a first set and a second set of seals projecting from an inner surface thereof. The first set of seals is longitudinally spaced from the second set of seals with all of the seals projecting in a plane that is transverse to the longitudinal axis. These seals project inwardly for a seal height sized to collapse against the exterior surface of the portion of conduit containing the space on opposite sides of the space.

While the above describes the broad structure of the invention, the present invention contemplates a more detailed structure, especially as adapted to be used with conduit having a circular cross-section. Where a circular cross-section conduit is provided, the invention provides a hollow cylindrical sleeve formed by first and second body sections constructed of a stiff material each as one half of the cylindrical sleeve. These two halves are securable together in the assembled state with their lateral side edges abutting. The seals are formed as first and second sets of circumferential fins which project radially inwardly from an inner surface of the sleeve at a fin height sized to collapse against the exterior surface of the portion of conduit on opposite sides of the space when assembled. The first set of fins is longitudinally spaced from the second set of fins.

While it is contemplated that the two half sections can be hinged together so that a single clasp member is provided, the present invention specifically contemplates that the two body sections be independent of one another but be assembled and fastened to one another by a pair of clasp members. To this end, each of the body sections has a longitudinally extending flange adjacent to each of its lateral edges. These flanges confront one another as flange pairs when assembled. While the clasp member may be a strip of material having a channel formed therein so that the flanges on the first and second body sections may be slid into the channel and locked by means of inwardly projecting ridges that engage the flange, it is preferred that the clasp member be a multi-piece structure that is movable between an open position and a closed position. Accordingly, the clasp device of the present invention includes a pair of movable jaws and a pair of jaw retainers. The jaw retainers have channels that hold the jaws in place. Both a surface of the jaws and a surface of the channels are provided with inclined and flat surfaces. The jaw retainers may reciprocate with respect to one another between an open position wherein the jaw members are spaced-apart from one another and a closed position wherein the jaw retainers abut one another. When this occurs, the inclined surfaces on the jaw members and in the channels cause the jaw members to move closer together thereby to clamp around the flanges of the first and second body sections.

To enhance the sealing of the first and second body sections around the conduit, it is desired that each of the first and second body sections include a pair of spaced-part fulcrum ribs on the inner surface with the fulcrum ribs projecting from the inner surface in a plane transverse to the longitudinal axis of the conduit at a rib height that is less than the height of the seals provided by the fins. In order to align the side edges into position, such that the first set of seals on the first and second body sections align with one another and such that the second set of seals on the first and second body sections align with one another, it is desired that alignment structures be located on the lateral side edges. These alignment structures can include a matable posts and bores operative to position the first and second body sections with respect to another.

As noted, it is desired that the first set of seals be defined by a set of upstanding fins formed on the inner surface of the first body section and projecting radially inwardly thereof. Likewise, it is desired that the second set of seals be defined by a second set of upstanding fins formed on the inner surface of the second body section and projecting radially inwardly thereof. It is preferred that the first set of fins form a common spiral structure when in the assembled state while the second set of fins form a second common spiral structure when in the assembled state. Ports are provided for the injection of an adhesive which may travel around these spiral structures after the splicing device is clamped onto the section of conduit. It is also desirable to provide third and fourth sets of seals, also in the form of fins. Here, however, the fins in the third and fourth sets of fins form a plurality of individual circumferential seals rather than a common spiral structure.

In any event, it is also desirable to seal the longitudinal edge pairs together. Thus, the confronting edges of each of the respective edge pairs are structured to mechanically interlock with one another. In a preferred embodiment, one of the confronting edges of each confronting edge pair has a groove formed therein and another of the confronting edges of each confronting edge pair has a tongue formed thereon with the tongue sized to mate with a groove. A portion of the tongue is separated into a plurality of fingers and a portion of the groove facing the fingers in the assembled state has upstanding prongs separated by gaps. The fingers are matable in the gaps when in the assembled state to prevent air leakage in a longitudinal direction. The fingers may be an extension of respective ones of the first and second seals. Here, each of the fingers include a web portion that is operative to align the respective first and second seals on the first and second body sections with one another in the assembled state.

The present invention is also directed to a method of joining two pieces of conduit together to seal a space therebetween. Broadly, the method includes the first step of forming a stiff sleeve around the conduit by positioning first and second body sections in surrounding relation thereto so that a portion of the sleeve extends longitudinally on either side of the space. Here, each of the first and second body sections includes a side wall forming a longitudinal channel to receive the conduit with the side wall having a pair of lateral side edges and a pair of opposite end edges. Each of the first and second body section includes a first and second set of mechanical seals projecting from an inner surface thereof with the first set of seals longitudinally spaced from the second set of seals. The method then includes the second step of mechanically compressing the first and second body sections together into an assembled state thereby to press the seals against the exterior surface of the portion of conduit on opposite sides of the space. Finally, this method includes the step of locking the first and second body sections together in the assembled state.

While the method according to the present invention includes all of the processing steps inherent in the mechanical structure described in this application, the method also can include the step of providing fulcrum ridges on the first end body sections so that forces of compression occurring during the step of mechanically compressing are distributed between the first and second seals. Further, the method can include the step of injecting a quantity of sealant proximately to the seals in a region between the conduit in the first and second body sections in a manner so as to completely surround the conduit.

These and other objects of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a perspective view of a splicing device according to a first exemplary embodiment of the present invention secured in an assembled state around a conduit of pre-determined size and cross-sectional geometry with a portion of this conduit shown in phantom;

FIG. 2 is an exploded perspective view of the conduit and splicing device shown in FIG. 1;

FIG. 3 is a perspective view of a first body section used to form the splicing device of FIGS. 1 and 2;

FIG. 4 is a top plan view of the first body section shown in FIG. 3;

FIG. 5 is an end view in elevation of the first body section shown in FIGS. 3 and 4;

FIG. 6 is a cross-sectional view taken about lines 6-6 of FIG. 4;

FIG. 7 is a perspective view of a second body section used to form the splicing device of FIGS. 1 and 2;

FIG. 8 is a top view in elevation of a second body section shown in FIG. 7;

FIG. 9 is an end view in elevation of the second body section shown in FIGS. 7 and 8;

FIG. 10 is a cross-sectional view taken about lines 10-10 of FIG. 8;

FIG. 11 is an enlarged top plan view of a lateral edge of the second body section of FIGS. 7-10 showing the second sealing fins and groove structure thereof;

FIG. 12 is a top plan view, similar to FIG. 11 but showing the second sealing fin in a collapsed state on a portion of conduit;

FIG. 13 is a top plan view, similar to FIG. 12, but showing the second sealing fins in a collapsed state with an adhesive sealant incorporated therewith;

FIG. 14 is a perspective view, partially broken-away, of a portion of the lateral edge of the first body section shown in FIGS. 3-6 illustrating the tongue structure and first and second sealing fins thereof;

FIG. 15 is a perspective view, similar to FIG. 14, but showing the lateral edge of the second body section along with the first and second sealing fins thereof to illustrate the groove structure thereof;

FIG. 16 is a perspective view of a first exemplary embodiment of the clasp member according to the present invention;

FIG. 17 is an exploded perspective view of the clasp member of FIG. 16 showing the pair of jaw members and the pair of jaw retainers therefor;

FIG. 18 is a front view in elevation of the clasp member shown in FIGS. 16 and 17;

FIG. 19 is a top plan view of a jaw member used in the clasp member of FIGS. 16-18;

FIG. 20 a front view in elevation of the jaw member shown in FIG. 18;

FIG. 21 is a bottom plan view of a jaw member shown in FIG. 18;

FIG. 22 is an end view in elevation of the jaw member shown in FIG. 18;

FIG. 23(a) a front view in partial cross-section of a jaw retainer used in the clasp member of FIGS. 16 and 17 showing a portion of the jaw member of FIG. 18 in an unlocked state;

FIG. 23(b) a front view in partial cross-section of a jaw retainer used in the clasp member of FIGS. 16 and 17 showing a portion of the jaw member of FIG. 18 in a locked state;

FIG. 24 is a perspective view of a splicing device according to a second exemplary embodiment of the present invention is an unassembled state; and

FIG. 25 is a perspective view of a splicing device according to a second exemplary embodiment of the present invention in an assembled state but with the clasp member therefor in an exploded perspective view.

### DETAILED DESCRIPTION OF THE EXEMPLARY EMBODIMENTS

The present invention is directed to a splicing device that is adapted to mount around a portion of conduit of pre-determined size and cross-sectional geometry. The splicing device is operative to seal a space in such conduit so that the conduit is isolated from external contaminates and, in addition, is substantially airtight. Normally, this space is defined by the junction interface of two separate pieces of conduit in a continuation conduit line. However, it should be understood that the splicing device of the present invention could also be used to seal around a rupture or a break in the conduit. Thus, for purposes of this invention, the term “space” includes the above-described situations and other gaps, ruptures or other spaces that might occur on a conduit line.

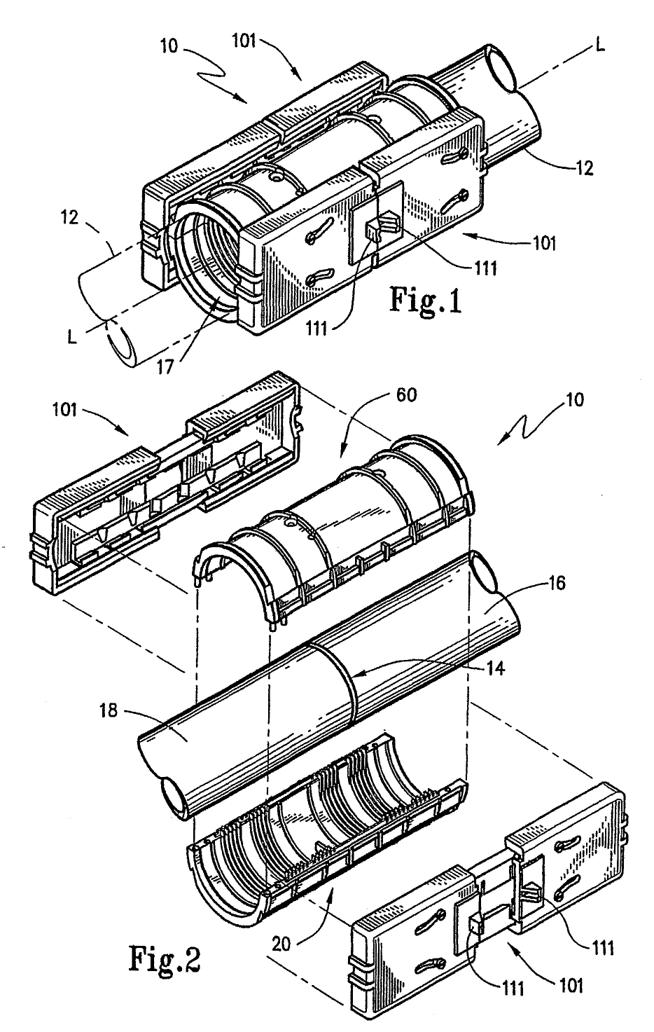

Accordingly, as is introduced in FIG. 1, splicing device 10 is shown mounted around a portion of conduit 12 that is a pre-determined size and cross-sectional geometry. In FIG. 1, conduit 12 is in the form of a tube having a circular cross-section such as that used with fiber optic cables or other electrical and data transmission applications. It should be understood, however, that the ordinarily skilled artisan could modify the cross-sectional geometry of splicing device 10 to accommodate conduits having other geometrical cross-sections including an oval cross-section, a polygonal cross-section or other cross-sections as currently used or as may be developed in the future.

In any event, as is best seen in FIGS. 1 and 2, splicing device 10 includes a first body section 20 and a second body section 60 that may be moved from an unassembled state, such as that shown in FIG. 2, to an assembled state, such as that shown in FIG. 1. Each of first and second body section 20 and 60 is preferably formed as an integral one-piece construction injection molded from any suitable plastic such as acetyl, HDPE, PVC, nylon or polyester, although nylon is not the preferred material. Splicing device 10 also includes a pair of clasp members 101 that mount on first and second body sections 20 and 60 to secure them in the assembled state shown in FIG. 1. With reference again to FIG. 2, it may be seen that splicing device 10 is here used to seal a space 14 that occurs at the juncture between two conduit sections 16 and 18 that form a continuous line. When secured together, first and second body sections form a sleeve 13 that has an axially extending chamber 17 with opposite sleeve end edges 15, all as shown in FIG. 1. Thus, axially extending chamber 17 is oriented along a central longitudinal axis “L”.

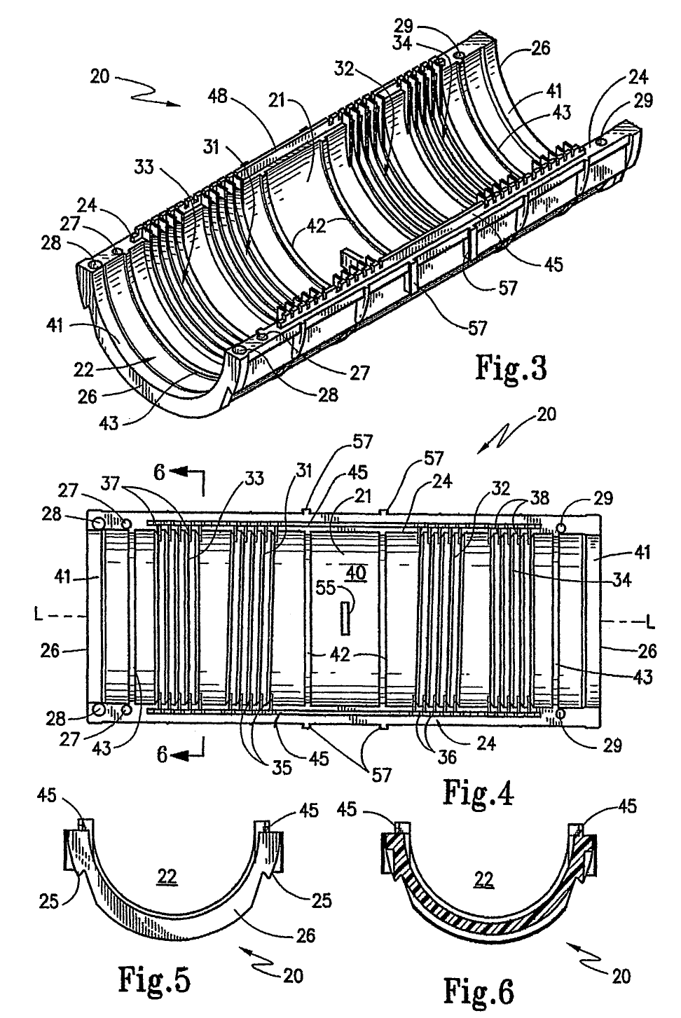

With reference to FIGS. 3-6, the structure of first body section 20 may be seen with greater particularity. Here, first body section 20 has an arcuate side wall 21 formed at a radius of curvature slightly greater than the external surface of the conduit 12. Arcuate side wall 21 forms a longitudinal channel 22 bounded by a pair of lateral side edges 24 and opposite end edges 26. First body section 20 includes a first set of seals 31 and a second set of seals 32 projecting from an inner surface of side wall 21 with the first set of seals being longitudinally spaced from the second set of seals 32. As is best shown in FIGS. 3 and 4, the first set of seals is defined by a first set of upstanding fins and, likewise, the second set of seals is defined by a second set of upstanding fins with all of such fins being formed on the inner surface of the first body section 20. As used herein, the term “set” is used to define situations where a single element (such as a single fin) or a plurality of elements (such as a plurality of fins) are contained within the set. In FIG. 3, it may be seen that five fins 35 and five fins 36 respectively define the first and second sets of seals 31 and 32. Fins 35 and 36, and thus the respective seals, project in a plane that is transverse to the longitudinal axis “L” at a seal height sized to collapsed against the exterior surface portion of the conduit on opposite sides of the space 14 when in the assembled state. As used herein, the term “transverse” includes orientations both oblique to and perpendicular to axis “L”.

First body section 20 also includes a third set of seals 33 and a fourth set of seals 34 that are longitudinally spaced from one another. The first set of seals 33 is again defined by upstanding fins 37 while second set of seals 34 are defined by upstanding fins 38. Fins 37 and 38 again extend circumferentially of first body section 20 a fin height, and thus at a seal height, that is sized to collapsed against the exterior surface of the portion of conduit on opposite sides of the space when in the assembled state. As is shown in FIG. 3, the first set of fins 35 and 36 are located intermediately of the third and fourth set of fins 37 and 38.

First body section 20 includes a pair of spaced-apart first fulcrum ribs 41 that are spaced-apart from one another and which project radially inwardly from the inner surface of first body section at a first rib height less than the fin height of fins 35-38. Preferably, each of the first fulcrum ribs 41 is proximate to a respective end edge 26 and, indeed, is adjacent thereto. First body section 20 also includes a pair of spaced-apart second fulcrum ribs 42 on inner surface thereof. Here, again, second fulcrum ribs 42 project radially inwardly from the inner surface of first body section 20 and a second rib height that is less than the fin height of fins 35-38. Second fulcrum ribs 42 are located intermediately of first fulcrum ribs 41, preferably along a central portion 40. A pair of third fulcrum ribs 43 are formed on the inner surface of first body section 20 and are longitudinally spaced from both first fulcrum ribs 41 and second fulcrum ribs 42. As is shown in FIGS. 3 and 4, third fulcrum ribs 43 are located between a respective first fulcrum rib 41 and the third and fourth sets of fulcrum ribs 37 and 38. Once again, ribs 43 are formed at a height that is less than the fin height, noted above.

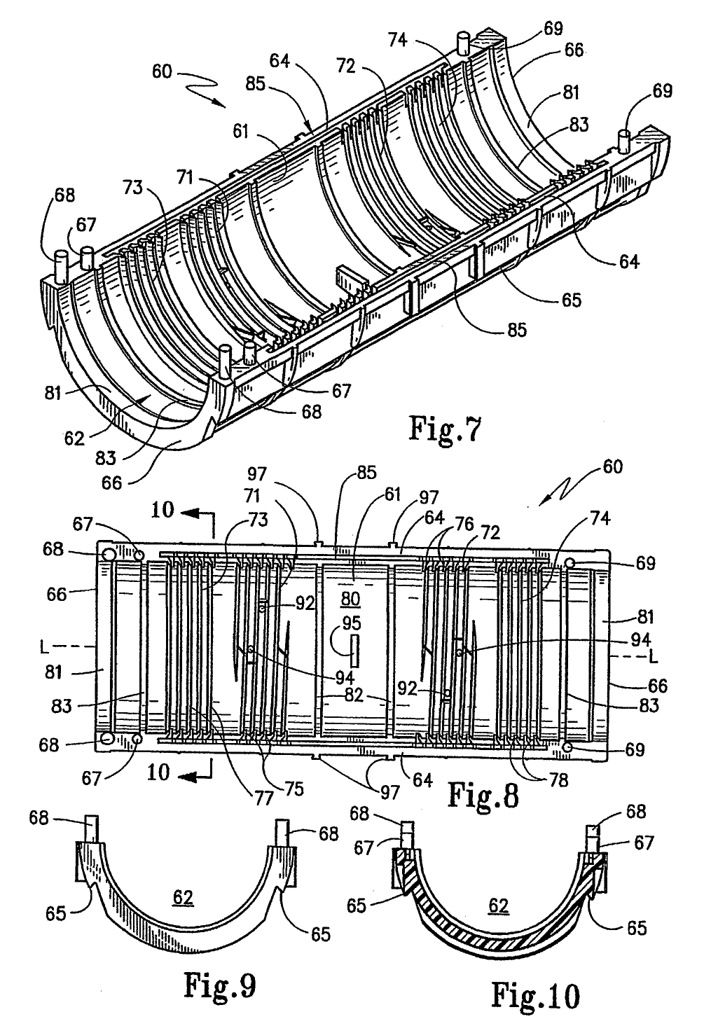

Turning now to FIGS. 7-10, the structure of second body section 60 is depicted in greater detail. As is shown, second body section 60 includes structure that is similar to that described with respect to first body section 20. In reference, then, to these Figures, it may be seen that second body section 60 includes an arcuate side wall 61 that forms a longitudinal channel 62. Side wall 61 has a pair of lateral side edges 64 and a pair of opposite end edges 66. A first and second set of seals 71 and 72 are formed, respectively, by a first and second set of fins 75 and 76 while a third set of seals 73 and a fourth set of seals 74 are respectively formed by a third and fourth set of fins 77 and 78. Fins 75-78 extend circumferentially around the inner surface of side wall 61 of body section 60 and project radially at a fin height sized to collapse against the exterior surface of the portion of conduit when in the assembled state.

A pair of first fulcrum ribs 81 are located adjacent to end edges 66 while a pair of second fulcrum ribs 82 are located and spaced-apart relationship to one another on central portion 80 of side wall 61. A pair of third fulcrum ribs 83 are located between a respective first fulcrum rib 81 and a respective second fulcrum rib 82 and is spaced part therefrom. The first set of seals 71 is located between a respective fulcrum rib 42 and a respective fulcrum rib 43; likewise, the second set of seals 72 is located between a respective second fulcrum rib 82 and a respective third fulcrum rib 83. The third set of seals 73 is located between the first set of seals 71 and a respective third fulcrum rib 83 and, likewise, fourth set of seals 74 is located between the second set of seals 72 and a respective third fulcrum rib 83. Fulcrum ribs 81-83 project radially inwardly of the inner surface of side wall 61 a distance that is less than the height of fins 75-78.

With reference now to FIGS. 2, 3 and 7, it should be appreciated that the lateral side edges 24 of first body section 20 and the lateral side edges 64 of second body section 60 are oriented to confront one another as respective confronting edge pairs when sleeve 13 is placed in the assembled state. When this occurs, channels 22 and 62 form the axially extending chamber 17. When in the assembled state, it is desired that the first set of fins 35 on first body section 20 align with the first set of fins 75 on second body sections 60 to form a first common spiral structure when in the assembled state. Likewise, the second set of fins 36 on first body section 20 and the second set of fins 76 on second body section 60 align to form a second common spiral structure in the assembled state. Similarly, the fins in the third set of fins 37 of first body section 20 and the fins in the third set of fins 77 of second body section 60 align with one another to form a plurality of spaced circular structures when sleeve 13 is in the assembled state. The fins in the fourth set of fins 38 of first body section 20 and the fins in the fourth set of fins 78 of second body section 60 align to form a plurality of spaced circular structures when the sleeve 13 is in the assembled state.

To facilitate the alignment of the above-described fins, it is desired that the confronting edges 24 and 64 of the respective edge pairs both register with one another and interlock with one another. In order to facilitate registration, lateral side edges 24 and 64 include registration structures operative to position the first and second body sections in the assembled states such as the first set of seals 31, 71 as defined by fins 35, 75 of the respective first and second body sections 20, 60 align with one another and so that the second set of seals 32, 72 as defined by fins 36, 76, align with one another as described above. The registration structures preferably include matable posts and bores in lateral edges 24 and 64. Accordingly, as is shown in FIG. 7, alignment posts 67, 68 and 69 project upwardly from lateral side edges 64 with posts 67 and 68 being located proximately to one end edge 66 of second body section 60 while post 69 is located proximately to the other end edge 66 of second body section 60. With reference now to FIG. 3, it may be seen that lateral side edges 24 of first body section 20 is provided with bores 27, 28 and 29 that are operative to receive, respectively, posts 67, 68 and 69. Bores 27 and 28 are thus located proximately to one end edge 26 of first body section 20 while bore 29 is located proximately to the other end edge 26 of first body section 20. By having a pair of posts and bores proximately to one end of the respective lateral edges of the body section and a single post or bore at the other end of the lateral edges assists in preventing an incorrect assembly of first and second body sections 20 and 60.

In order that clasp members 101 are able to engage first and second body sections 20 and 60, a longitudinal flange 25 is provided approximately to each lateral side edge 24 of first body section 20. Likewise, a longitudinally extending flange 65 is provided proximately to each longitudinal edge 64 of second body section 60. When assembled, a respective pair of flanges 25, 65 project oppositely one another. Further, to help register the end of a conduit in sleeve 13 during installation, the central portion 40 of first body section 20 includes a radially inwardly projecting flat lug 55 oriented transversely of axis “L”. Likewise, the central portion 80 of second body section 60 includes a radially inwardly projecting flat lug 95 oriented transversely of axis “L”. Lugs 55 and 95 act as limit stops to ensure that the space 14 between the ends of the conduit section are registered centrally of sleeve 13. Where splicing device 10 is to be employed to seal a rupture in the conduit 12, it may be necessary to cut lugs 55 and 95 off prior to use.

In order to facilitate the engagement an assembly of first and second body sections 20 and 60 into sleeve 13, it is desired that their respective edge pairs 24, 64 mechanically interlock with one another. To accomplish this, one of the confronting edges of each confronting edge pair has a groove formed therein while another of the confronting edges of each confronting edge pair has a tongue formed thereon with this tongue being sized to mate with the groove. With reference to FIGS. 3-6, it may be seen that each lateral edge 24 of first body section 20 includes a longitudinally extending tongue 45 projecting upwardly therefrom. Likewise, with reference to FIG. 7-10, it may be seen that each lateral side edge 64 of second body section 60 includes a longitudinally extending groove 85. It should be understood that tongues 45 mate with grooves 85 when in the assembled state thereby to mechanically interlock first and second body sections 20, 60 together.

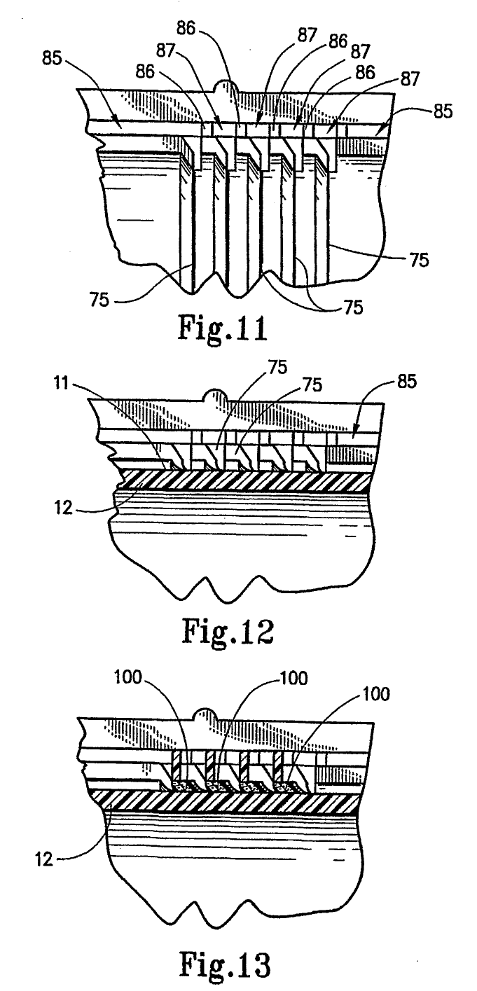

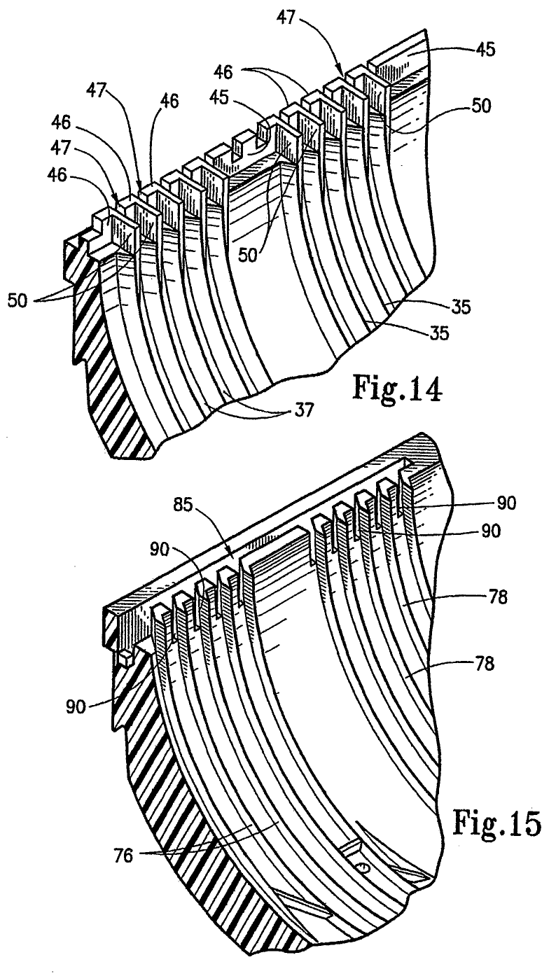

As noted above, it is desirable that the splicing device 10 according to the present invention provide a relatively airtight seal about the space 14. Accordingly, it is necessary to reduce fluid communication around space 14 that may occur through grooves 85 even when tongues 45 are inserted therein. To reduce longitudinal fluid flow through the grooves 85 then, a portion of each tongue 45 is separated into a plurality of fingers 46 with gaps 47 therebetween that are best shown in FIG. 14. A portion of the grooves 85 facing these fingers 46 is correspondingly provided with upstanding prongs 86 that are separated by gaps 87, as is best shown in FIG. 11. When assembled, the ends of fingers 46 extend into gaps 87 while prongs 86 extend into the gaps 47 between fingers 46. The skilled artisan should recognize that it is necessary to properly dimension the height of prongs 86 and fingers 46 so as to provide an interference fit when they interlock, respectively, in gaps 47 and gaps 87.

It is preferred that each of fingers 46 be an extension of the respective first and second seals as defined by the fins, described above. In order to facilitate alignment of the fins, and is best shown in FIGS. 14 and 15, fingers 46 each include a web portion 50 that engage respective slits 90 when lateral edges 24, 64 interlock. Webs 50 and slits 90 thus further act to align the respective first and second seals together. It should be understood, with respect to the preferred exemplary embodiment, that each of fins 35-38 is provided with such a web 50 at its lateral edge 24 while each of fins 75-78 are provided with slits 90 also adjacent its respective lateral edge 64.

With reference now to FIGS. 11-13, it may be seen that, in the assembled state, representative fins 75 seal against the peripheral surface of conduit 12 by collapsing thereagainst when first and second body sections 20, 60 are interlocked together in the assembled state. In FIG. 11, it may be seen that representative fin 75 are not collapsed, but, as is shown in FIG. 12, collapse and bear against surface 11 of conduit 12. As noted above, fins 75 along with fins 35 form a single spiral thread that now extends around conduit 12 in the assembled and mounted state. To further seal splicing device 10 to conduit 12, a suitable adhesive material 100 may be inserted in the spiral seals such as those formed by the combination of fins 35, 75 and 36, 76. To facilitate introduction of this sealant after sleeve 13 is assembled, a pair of ports 92 and 94 are provided through side wall 61 for each of first and second set of seals 71 and 72. Each pair of ports 92, 94 are rotationally separated from one another by at least 360° with respect to these spiral threads. Thus, when adhesive is introduced into either port 92 or port 94 of a port pairs 92, 94, it flows completely around conduit 12 between peripheral surface 11 and the inner surface of body members 20, 60 until it exists the other of ports 92, 94. By this location of ports 92 and 94, it is assured that the injected adhesive encircles conduit 12 at least once to provide the additional physical seal between the splicing device and conduit 12. Thus, as is shown in FIG. 13, sealant 100 provides a bond to conduit 12.

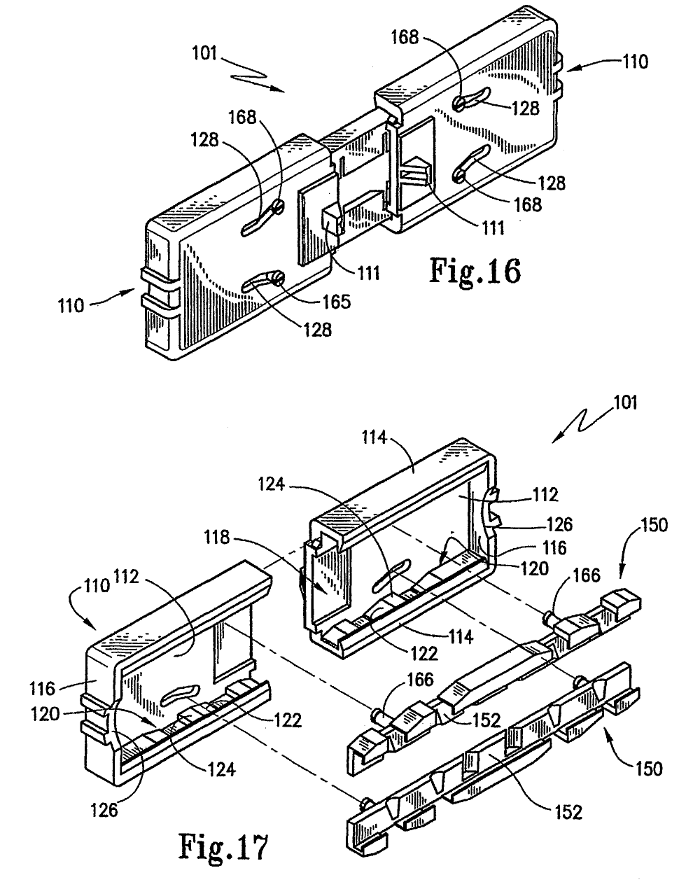

Finally, with respect to the exemplary embodiment of the present invention, it is desired to mechanically lock first and second body sections 20 and 60 together. To accomplish this, as noted above, a pair of clasp members 101 are provided. The structure of clasp member 101 is shown in FIGS. 16-18. Here, it can be seen that clasp member 101 includes a pair of identical jaw retainers 110 which receive a pair of identical jaws 150, the structure of which is described more thoroughly below. With reference to FIG. 17, it may be seen that each jaw retainer 110 includes a central wall 112 and a pair of opposed lateral walls 114. Lateral walls 114 are connected, at opposite ends, by an end wall 116 so that an entryway 118 is located at an end of jaw retainer 110 opposite end wall 116. Lateral walls 114 form a pair of opposed channels 120 operative to receive jaw members 150, as more thoroughly described below. Each of channels 120 includes a plurality of ramp structures defined by inclined surfaces 122 connected to flat surfaces 124. As may be seen in FIG. 17, each channel 120 has three such ramp structures.

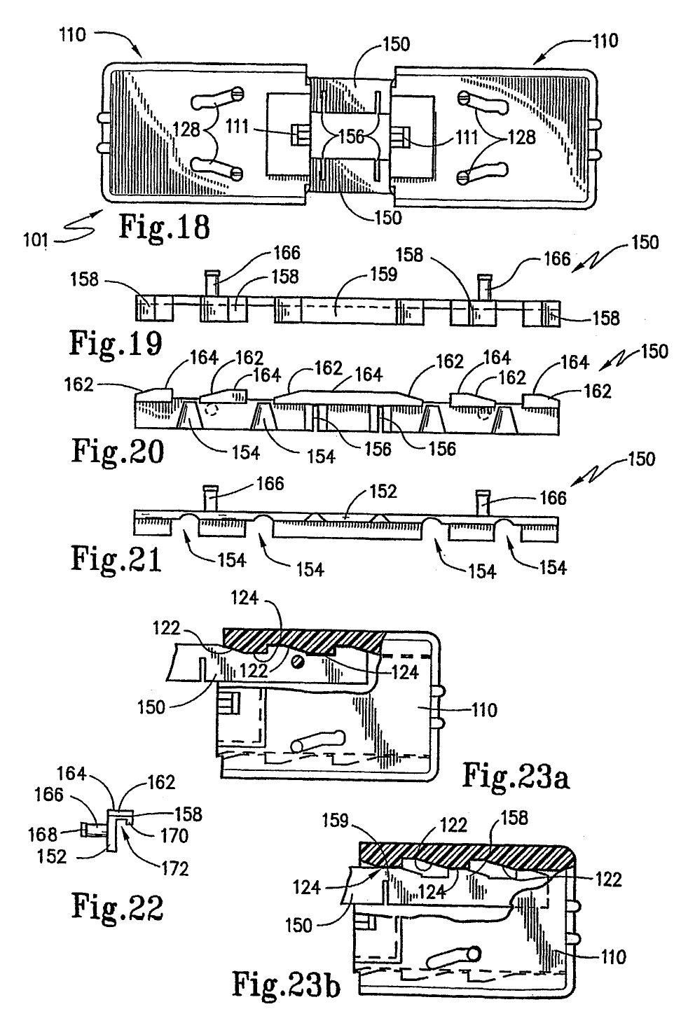

Each of end walls 116 includes an arcuate cut-out 126 to accommodate circular conduit 12 when splicing device 10 is mounted thereon. Central wall 112 has a pair of spaced-apart slots 128 which cooperate with channels 120 in mounting and actuating jaw members 150. With a review of FIGS. 1 and 16-18, it may be seen that jaw retainers 110 may move toward one another to a closed position (shown in FIG. 1) to an open position (as shown in FIGS. 16 and 18).

A jaw member 150 is shown in greater detail in FIGS. 19-22. Here, it may be seen that each jaw member 150 is formed by an elongated rib 152 provided with a plurality of scallops 154 and a pair of spaced-apart slits 156 located at a central region thereof. A plurality of ramp structures 158 and 159 project perpendicularly from rib 152 and are formed by inclined surfaces 162 and flat surfaces 164 which, as described below, interact with inclined surfaces 122 and flat surfaces 124 to move jaw members 150 into a locked position when jaw retainers 110 are moved to the closed position. A pair of retaining posts 166 project from rib 152 in a direction opposite ramp structures 158, 159 and terminate in slightly enlarged heads 168. When jaw members 150 are mounted in channels 120, posts 166 mate with slots 128 both to retain jaw members 150 in the mounted state and to help guide jaw members 150 during the locking and unlocking thereof. With reference to FIG. 22, it may be seen that each ramp structure, such as ramp structure 158, has inwardly turned ridge 170 which forms a locking channel 172 with rib 152.

The assembly and operation of clasp members 101 can now be appreciated with reference to FIGS. 1 and 16-23. As may be seen in these Figures, each jaw member 150 is received in a respective channel 120. Posts 166 engage slots 128 with heads 168 resisting removal therefrom. When jaw retainers 110 are in the open position, such as shown in FIGS. 16, 18 and 23(a), ramp structures 158 and 159 are positioned so that inclined surfaces 162 thereof abut inclined surfaces 122 of jaw retainers 110 so that jaw members 150 are in the unlocked position. However, when jaw retainers 150 are moved together into the closed position shown in FIG. 1, inclined surfaces 122 and 162 abut on one another until flat surfaces 124 of jaw retainers 110 abut flat surfaces 164 of ramp structures 158 and 159. This is shown in FIG. 23(b). Because of the nature of these inclined surfaces, jaw members 150 are forced to move together into a locked state. When this occurs, ridges 170 which form channels 172 engage flanges 25 and 65 of first body section 120 and second body section 160 thereby drawing body sections 120, 160 into the assembled state. When jaw retainers 110 move into the closed position, shown in FIG. 1, end walls 116 respectively abut into edges 26 and 66 to further facilitate clamping of clasp members 101 and 102 thereon. Prior to closing jaw retainers 110, it may now also be appreciated that slits 156 of jaw members 150 can engage retaining webs 57 and 97, respectively, on flanges 25 and 65 of first and second body sections 20 and 60 for ease of mounting, assembly and guidance during the locking operation. To allow for mechanical advantage in closing clasp member 101, that is by moving retainer members 110 from the open position to the closed position, each retainer is provided with an outwardly oriented ear 111 that can be engaged, for example, by a pair of pliers or other tool operative to force the retainer members toward one another.

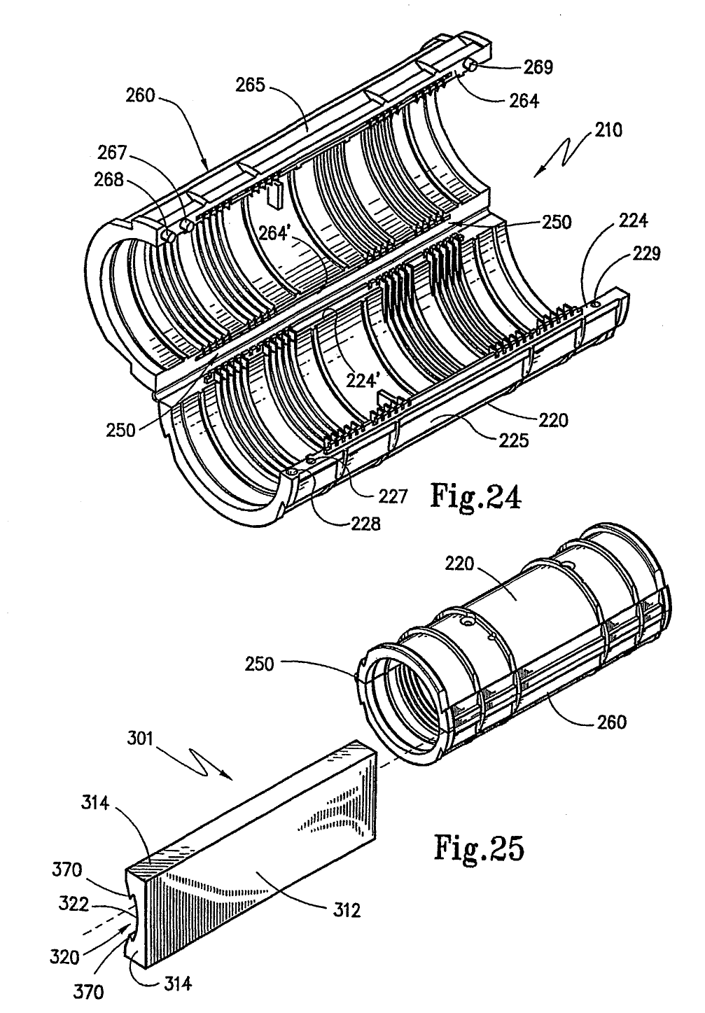

With reference now, to FIGS. 24 and 25, an alternative embodiment of the present invention is shown. Here, splicing device 210 is in the form of a clam shell having a first body section 220 and a second body section 260 secured together along a living hinge 250 to one another. Accordingly, a single pair of flanges 225 and 265 are located along lateral side edges 224 and 264 of first and second body sections 220 and 260.

It should be understood that the internal structure of each of first body section and second body section 260 are substantially identical to that described with respect to first body section 20 and second body section 60 so that it is not again repeated. Likewise, the structure of flanges 225 and 265 are the same as a pair of flanges 25 and 65 of first body section 20 and second body section 60 described in greater detail above. Accordingly, this structure is also not further described since it should be apparent to the ordinarily skilled person in this field with reference to FIGS. 24 and 25 along with the above detailed description of flanges 25 and 65. However, it should be appreciated that each of body sections 220 and 260 have a pair of flanges omitted therefrom in favor of living hinge 250, and it should be appreciated that, by virtue of the living hinge 250, lateral edges 224′ and 264′ are held in position. To this end also, a set of posts 267, 268 and 269 are eliminated from lateral edges 164′ and the corresponding bores 227, 228 and 229 are eliminated from lateral edges 224′.

Also, as is shown in FIG. 25, an alliterative clasp member 301 is shown to lock first and second body sections together with lateral edges 224 and 264 in abutting relationship. Here, It may be seen that clasp member 101 is in the form of an elongated strip having a central wall 312, a pair of opposed lateral walls 314 which defines an arcuate channel 320 therebetween. The upper surface of lateral walls 314 are provided with opposed longitudinally extending ridges 370 which are opposed to one another to engage flanges 225 and 265 when in the assembled state thereby to lock them together. To this end, also, lower surface 322 of channel 320 is arcuate in shape to accommodate the arcuate upper surfaces of flanges 225 and 265. Thus, when first and second body sections 220 and 260 are assembled, as is shown in FIG. 25, clasp 301 can be longitudinally slid onto flanges 225 and 265 thereby to retain first and second body sections 220 and 260 in the assembled state.

From the foregoing, it should be appreciated that the present invention also contemplates a method of joining two pieces of conduit together to seal a space therebetween. This method includes all of the steps inherent in the above described structure. Broadly, however, the method according to the present invention includes forming a stiff sleeve around the conduit by positioning first and second body sections in surrounding relation thereto so that a portion of the sleeve extends longitudinally on either side of the space. This step is accomplished by first and second body sections which include a side wall forming a longitudinal channel to receive the conduit, with a pair of lateral side edges and opposite end edges. Further, this step is accomplished by first and second body sections that include first and second sets of mechanical seals projecting from an inner surface thereof with the first set of seals longitudinally spaced from the second set of seals. Next, the method contemplates mechanically compressing the first and second body sections together in an assembled state thereby to press the seals against the exterior surface of the portion of conduit on opposite sides of the space. Finally, the method includes the step of locking the first and second body sections together in the assembled state. The method according to the present invention can also include the steps of providing fulcrum regions on the first and second body sections so that forces of compression occurring during the step of mechanically compressing are distributed between the first and second seals. Also, the present invention can include the step of injecting a quantity of sealant proximately to the seals in a region between the conduit and the first and second body sections in a manner to completely surround the conduit.

Accordingly, the present invention has been described with some degree of particularity directed to the exemplary embodiment of the present invention. It should be appreciated, though, that the present invention is defined by the following claims construed in light of the prior art so that modifications or changes may be made to the exemplary embodiment of the present invention without departing from the inventive concepts contained herein.

We claim:

1. A splicing device adapted to mount around a portion of conduit of predetermined size and cross-sectional geometry to seal a space therein, comprising:
(a) first and second body sections securable together in an assembled state thereby to form a sleeve having a cross-section geometrically similar to said conduit and sized to surround the portion of conduit, each of said first and second body sections including a sidewall forming a longitudinal channel with said sidewall having a pair of lateral side edges and opposite end edges, the lateral side edges of said first body section and the lateral side edges of said second body section oriented to confront one another as respective confronting edge pairs when in the assembled state such that the channels form an axially extending chamber having a central longitudinal axis, said sleeve sized and adapted for close-fitted engagement with an exterior surface of the portion of conduit, each of said first and second body sections including a first and a second set of seals projecting from an inner surface thereof with said first set of seals longitudinally spaced from said second set of seals, said seals projecting in a plane transverse to the longitudinal axis at a seal height sized to collapse against the exterior surface of the portion of conduit on opposite sides of the space when in the assembled state;
(b) at least one clasp member operative to secure said first and second sections together and retain them in the assembled state.

2. A splicing device according to claim 1 wherein each of said first and second body sections includes a pair of spaced-apart fulcrum ribs on the inner surface thereof, said fulcrum ribs projecting from the inner surface thereof in a plane transverse to the longitudinal axis at a rib height less than the seal height.

3. A splicing device according to claim 1 wherein said lateral side edges include registration structures operative to position said first and second body sections in the assembled state such that the first set of seals on said of first and second body sections align with one another and such that the second set of seals on said first and second body sections align with one another.

4. A splicing device according to claim 3 wherein said registration structures includes matable posts and bores on said lateral edges.

5. A splicing device according to claim 1 wherein said first and second sets of seals are respectively defined by a first and a second set of upstanding fins formed on the inner surface of the respective first and second.

6. A splicing device according to claim 5 wherein the first set of fins on said first and second body sections form a first common spiral structure when in the assembled state and wherein the second set of fins on said first and second body sections form a second common spiral structure when in the assembled state.

7. A splicing device according to claim 6 including a first pair of ports through said sidewall in fluid communication with said first spiral structure and a second pair of ports through said sidewall in fluid communication with said second spiral structure.

8. A splicing device according to claim 1 wherein the confronting edges of each of the respective edge pairs mechanically interlock with one another.

9. A splicing device according to claim 8 wherein one of the confronting edges of each confronting edge pair has a groove formed therein and another of the confronting edges of each confronting edge pair has a tongue formed thereon, said tongue sized to mate with said groove.

10. A splicing device according to claim 9 wherein a portion of the tongue is separated into a plurality of fingers and wherein a portion of the groove facing said fingers in the assembled state has upstanding prongs separated by gaps, said fingers matable in said gaps when in the assembled state.

11. A splicing device according to claim 10 wherein said fingers are an extension of respective ones of said first and second seals and wherein each of said fingers includes a web portion operative to align the respective first and second seals on said first and second body sections with one another when in the assembled state.

12. A splicing device according to claim 1 wherein said first and second body sections each include at least one longitudinal flange on an outer surface thereof adjacent to a respective lateral edge such that said flanges are in opposed relation with one another when in the assembled state, said clasp member operative to releasably clamp said flanges together to retain said first and second body sections in the assembled state.

13. A splicing device according to claim 12 wherein said first and second body sections each include a said longitudinal flange on an outer surface thereof adjacent to each respective lateral edge such that said flanges are in opposed relation with one another when in the assembled state and including a pair of clasp members operative to releasably clamp said flanges together to retain said first and second body sections in the assembled state.

14. A splicing device according to claim 12 wherein said clasp member includes a pair of jaws and a pair of jaw retainers, said jaw retainers being relatively movable with toward one another from an open position to a closed position thereby to move said jaws from an unlocked position to a locked position, said jaws positional on said flanges when the clasp is in the open position and operative in the locked position to clamp said flanges together.

15. A splicing device according to claim 14 wherein said jaw retainers have opposed channels each receiving one of said jaws with the channels each having first inclined surfaces on a bottom thereof, said jaws including second inclined surfaces positioned such that said first and second inclined surfaces coact when said jaw retainers are moved toward one another to advance the jaws toward the locked position.

16. A splicing device according to claim 15 wherein said jaw retainers each have a pair of slots and said jaws include a plurality of retaining posts respectively received in the slots thereby to hold said jaws in said channels during movement thereof.

17. A splicing device according to claim 14 wherein each of said jaw retainers includes an end stop, said end stops operative to abut the opposite end edges of said first and second body sections when said jaw retainers are moved together into the closed position.

18. A splicing device according to claim 14 wherein said jaw retainers and said flanges including matable structures to retain said clasps on said sleeve prior to advancing the jaws into the closed position.

19. A splicing device adapted to mount around a portion of cylindrical conduit of predetermined size to seal a space therein, comprising:
(a) a hollow cylindrical sleeve sized to surround the portion of conduit and including a surrounding sidewall with opposite sleeve end edges and forming an axial chamber oriented about a central longitudinal axis with opposite end openings, said sleeve formed by first and second body sections constructed of a stiff material as one-half of said cylindrical sleeve and securable together in an assembled state thereby to form said sleeve, each of said first and second body sections including an arcuate sidewall portion forming a longitudinal channel with said sidewall portion having a pair of lateral side edges and opposite end edges, the lateral side edges of said first body section and the lateral side edges of said second body section oriented to confront one another as respective confronting edge pairs when in the assembled state such that the channels form the axially extending chamber, said sleeve sized and adapted for close-fitted engagement with an exterior surface of the portion of conduit, each of said first and second body sections including a first and a second set of circumferential fins projecting radially inwardly from an inner surface thereof at a fin height sized to collapse against the exterior surface of the portion of conduit on opposite sides of the space when in the assembled state with said first set of fins longitudinally spaced from said second set of fins;
(b) first and second clasp members together operative to secure said first and second sections together and retain them in the assembled state.

20. A splicing device according to claim 19 wherein each of said first and second body sections includes a pair of spaced-apart first fulcrum ribs on the inner surface thereof, said fulcrum ribs projecting radially from the inner surface thereof at a first rib height less than the fin height.

21. A splicing device according to claim 20 wherein each of said first fulcrum ribs is proximate to a respective said end edge.

22. A splicing device according to claim 21 wherein each of said first and second body sections includes a pair of spaced-apart second fulcrum ribs on the inner surface thereof, said second fulcrum ribs projecting radially from the inner surface thereof at a second rib height less than the fin height, said second fulcrum ribs located intermediately of said first fulcrum ribs.

23. A splicing device according to claim 22 wherein each said first and second set of fins is located between a respective first fulcrum rib and a respective second fulcrum rib.

24. A splicing device according to claim 19 wherein each of said first and second body sections includes a third and a fourth set of circumferential fins projecting radially inwardly from an inner surface thereof at a fin height sized to collapse against the exterior surface of the portion of conduit on opposite sides of the space when in the assembled state with said first set of fins longitudinally spaced from said second set of fins.

25. A splicing device according to claim 24 wherein fins in said first and second sets of fins of said first and second body sections form circular structures and wherein fins in said third and fourth body sections are each defined by a spiral thread.

26. A splicing device according to claim 19 wherein the confronting edges of each of the respective edge pairs mechanically interlock with one another.

27. A splicing device according to claim 26 wherein one of the confronting edges of each confronting edge pairs has a groove formed therein and another of the confronting edges of each confronting edge pairs has a tongue formed thereon, said tongue sized to mate with said groove.

28. A splicing device according to claim 27 wherein a portion of the tongue is separated into a plurality of fingers and wherein a portion of the groove facing said fingers in the assembled state has upstanding prongs separated by gaps, said fingers matable in said gaps when in the assembled state.

29. A splicing device according to claim 28 wherein said fingers are an extension of respective ones of said first and second fins and wherein each of said fingers includes a web portion operative to align the respective first and second fins on said first and second body sections with one another when in the assembled state.

30. A splicing device according to claim 19 wherein said first and second body sections each include a said longitudinal flange on an outer surface thereof adjacent to each respective lateral edge such that said flanges are in opposed relation with one another when in the assembled state, said first and second clasp members operative to releasably clamp said flanges together to retain said first and second body sections in the assembled state.

31. A splicing device according to claim 19 wherein said clasp member includes a pair of jaws and a pair of jaw retainers, said jaw retainers being relatively movable with toward one another thereby to move said jaws from an open position to a closed position, said jaws positionable on said flanges when in the open position and operative in said closed position to clamp said flanges together.

32. A splicing device according to claim 19 wherein at least one of said first and second body sections includes a radially inwardly projecting tab disposed on a central portion of the inner surface thereof, said tab sized and adapted to be positioned in the space in said conduit.

33. A method of joining two pieces of conduit together to seal a space therebetween, comprising the steps of:
(a) forming a stiff sleeve around the conduit by positioning first and second body sections in surrounding relation thereto so that a portion of said sleeve extends longitudinally on either side of the space wherein each of said first and second body sections includes a sidewall forming a longitudinal channel to receive the conduit with said sidewall having a pair of lateral side edges and opposite end edges, each of said first and second body sections including a first and a second set of mechanical seals projecting from an inner surface thereof with said first set of seals longitudinally spaced from said second set of seals;
(b) mechanically compressing said first and second body sections together in an assembled state thereby to press said seals against the exterior surface of the portion of conduit on opposite sides of the space; and
(c) locking said first and second body sections together in the assembled state.

34. The method according to claim 33 including the step of providing fulcrum regions on said first and second body sections so that forces of compression occurring during the step of mechanically compressing are distributed between said first and second seals.

35. The method according to claim 33 including the step of injecting a quantity of a sealant proximately to said seals in a region between the conduit and said first and second body sections in a manner to completely surround said conduit.
